(19) United States
(12) Patent Application Publication
(10) Pub. No.: US 2024/0052219 A1
(43) Pub. Date: Feb. 15, 2024

(54) ANAEROBICALLY CURABLE COMPOSITIONS

(71) Applicant: Henkel AG & Co. KGaA, Duesseldorf (DE)

(72) Inventors: Gavin Haberlin, Naas (IE); Michael Doherty, Clane (IE); Nigel Sweeney, Dublin (IE); Rory Barnes, Dublin (IE); David Condron, Dublin (IE); Barry Burns, Dublin (IE)

(21) Appl. No.: 18/489,991

(22) Filed: Oct. 19, 2023

Related U.S. Application Data
(63) Continuation of application No. PCT/EP2022/060629, filed on Apr. 21, 2022.

(30) Foreign Application Priority Data
Apr. 21, 2021 (GB) 2105715.3

(51) Int. Cl. C09J 175/08; C09J 133/10; C09J 167/00; C09J 7/30; F16B 39/22

(52) U.S. Cl. CPC C09J 175/08; C09J 133/10; C09J 167/00; C09J 7/30; F16B 39/225; C09J 2475/00; C09J 2433/00; C09J 2467/00

(57) ABSTRACT

An anaerobically curable composition comprising:
a liquid anaerobically curable component;
a solid anaerobically curable component;
a solid polyether thermoplastic polyurethane resin; and
a curing component for curing the anaerobically curable components.

Advantageously, the compositions of the invention are substantially solid and may be used as threadlockers.

### BACKGROUND

### Field

The present invention relates to anaerobically curable compositions which can be used in many applications including as threadlockers. The compositions are substantially solid and may be provided in any suitable solid form including tape form, filament form or as a coating applied to a substrate including for example a filament or thread made from another material such as a nylon or polyester thread. The present invention also relates to a method of preparing a threaded part and a method of assembling threaded parts. The compositions can be easily handled and applied to threaded members. The compositions are thermally resistant at temperatures of at least 150° C.

### Brief Description of Related Technology

Threadlocking compositions are employed to lock and/or seal threaded parts such as nuts and bolts together in an interlocked state. Such threadlocking compositions significantly increase the torque required to break or turn the engaged threaded parts. Conventional threadlocking compositions oftentimes include co-reactive adhesive systems, where two or more components are mixed before applying the resulting composition to the threaded engagement surface(s) of the fastener on which the components in the threadlocking composition react to cure. Examples of such co-reactive systems include epoxy resin adhesive compositions.

Liquid adhesive compositions have long been used in sealing and threadlocking applications and have become a standard part of assembly production as well as in the maintenance of machinery, tools and the like. Among the liquid adhesive compositions commonly used in these applications are anaerobic compositions. These compositions provide excellent threadlocking and sealing properties when cured. Anaerobically curable compositions which are applied as threadlocking compositions to threaded parts remain stable (in an uncured state), and thus in liquid form, until they are placed between interlocked threaded parts where they cure in the absence of oxygen.

Anaerobically curable compositions generally are well known. See e.g. R. D. Rich, “Anaerobic Adhesives” in Handbook of Adhesive Technology, 29, 467-79, A. Pizzi and K. L. Mittal, eds., Marcel Dekker, Inc., New York (1994), and references cited therein. Their uses are legion and new applications continue to be developed.

Anaerobic adhesive systems are those which are stable in the presence of oxygen, but which polymerize in the absence of oxygen. Polymerization is initiated by the presence of free radicals, often generated from peroxy compounds. Anaerobic adhesive compositions are well known for their ability to remain in a liquid, unpolymerized state in the presence of oxygen and to cure to a solid state upon the exclusion of oxygen.

Oftentimes anaerobic adhesive systems comprise resin monomers terminated with polymerizable acrylate ester such as methacrylate, ethylacrylate and chloroacrylate esters [e.g., polyethylene glycol dimethacrylate and urethane-acrylates (e.g., U.S. Pat. No. 3,425,988 (Gorman)] derived according to known urethane chemistry. Other ingredients typically present in anaerobically curable adhesive compositions include initiators, such as an organic hydroperoxide for example cumene hydroperoxide, tertiary butyl hydroperoxide and the like, accelerators to increase the rate at which the composition cures, and stabilizers such as quinone or hydroquinone, which are included to help prevent premature polymerization of the adhesive due to decomposition of peroxy compounds.

Desirable cure-inducing compositions to induce and accelerate anaerobic cure may include one or more of saccharin, toluidines, such as N,N-diethyl-p-toluidine (“DE-p-T”) and N,N-dimethyl-o-toluidine (“DM-o-T”), and acetyl phenyl hydrazine (“APH”) with maleic acid. See e.g. U.S. Pat. Nos. 3,218,305 (Krieble), 4,180,640 (Melody), 4,287,330 (Rich) and 4,321,349 (Rich).

Saccharin and APH are used as standard cure accelerator components in anaerobic adhesive cure systems. Indeed, many of the LOCTITE®-brand anaerobic adhesive products currently available from Henkel Corporation use either saccharin alone or both saccharin and APH.

Anaerobically curable adhesive compositions also commonly include chelators such as ethylenediamine tetraacetic acid (EDTA) which are employed to sequester metal ions.

Compositions that are suitable for use in pre-applied threadlocking applications are typically applied in a dry to touch form but with later stage anaerobic cure functionality.

In some cases the dry to touch form is achieved using a cure mechanism. For example a first cure mechanism may form the dry to touch form so as to hold the composition in place on an article while a second cure mechanism is activated later to achieve threadlocking.

For example European Patent No. 0 077 659 (Thompson) describes a pre-applied polymerizable fluid for sealing and locking engineering parts. The composition has two mechanisms for curing and two curing reactions take place. The first mechanism is a UV light cure. An opacifier is dispersed in the fluid so that the fluid becomes substantially opaque to radiation. After the fluid is applied to the component it is exposed to UV radiation whereupon a coating is formed, creating a surface layer which is a dry, tack-free crust. The subcutaneous fluid is unaffected by the radiation and remains in a generally liquid state. When the component is threaded into another the surface layer breaks and the second polymerisation (such as a free radical polymerization) is initiated and the second cure reaction takes place once an anaerobic environment is established as the threaded components interlock. The second polymerization mechanism acts to lock the threads together. In Thompson, only a skin is formed in the first polymerization and the remainder of the composition remains fluid below the skin. There is a risk therefore that during handling of the coated engineering parts the skin may be disrupted and the fluid composition may leak out.

Similarly, European Patent No. 0 548 369 (Usami) describes a pre-applied adhesive composition for application to the threaded contact faces of a screw member such as a screw. The composition comprises a photo-hardening binder in which a secondary curable composition is dispersed. The secondary curable composition includes microencapsulated reactive monomer/activator/initiator.

International Patent Publication WO2004/024841 A2 (Haller) describes curable compositions for application to a threaded article. The composition comprises a dispersion of components of a first cure mechanism comprising: (a) a (meth)acrylate functional monomer component; (b) a (meth)acrylate functional oligomer component; and (c) a photoinitiator component; and (ii) components of a second cure mechanism comprising: (e) an amine component; and (f) an encapsulated epoxy resin component; together with (iii) a thickener component. The photoinitiator component is suitable upon irradiation of the composition to achieve a first cure through the depth of the composition applied to a threaded article so that a binder matrix is formed with the components of the second cure mechanism dispersed through the matrix.

U.S. Pat. No. 9,181,457 (Attarwala) describes dry-to-the-touch compositions containing a polymeric matrix and an anaerobically curable component present within the polymeric matrix. In a particularly desirable form, the compositions are moisture curable. The compositions are non-flowable at high temperatures, and have an improved solvent resistance once cured. The compositions are useful as threadlocking compositions, and can be formulated as coatings on a carrier substrate, such as a tape, a string or a sheet.

British Patent No. 2,543,756 (Ledwith) describes a threadlocking composition comprising an anaerobically curable component and a curing component for curing the anaerobically curable component; wherein the composition is in flowable particulate form and has a melting point in the range 30-100° C. The anaerobically curable component may comprise an anaerobically curable monomer and a resin component. The composition may be provided in at least two-part form. The anaerobically curable component is preferably provided in powder form. Preferably the resin component is selected from methacrylated polyurethane resins, novolac resins or higher methacrylated polyester resins. The anaerobically curable monomer preferably comprises at least one acrylate or methacrylate ester group. The composition is preferably solvent-free. Also disclosed is a method of threadlocking two threaded articles together comprising applying said composition to the threads of at least one article so as to fuse it by melting to the threads; subsequently, and optionally after cooling, threading the two articles together so as to initiate anaerobic cure of the threadlocking composition so as to chemically bond the two articles together. An article having said composition applied thereto is also disclosed.

U.S. Patent Application Publication No. 4,039,705 (Douek) is concerned with anaerobically curable pressure sensitive adhesive stocks such as sheets and tapes from which a pressure sensitive adhesive layer including at least one anaerobic resin system which can be completely transferred to one substrate to be bonded to another, and cured upon activation by a peroxy initiator and the exclusion of oxygen. The anaerobic pressure sensitive adhesive is contained between two different release surfaces, which enables transfer of the pressure adhesive to a substrate which is to be firmly secured to another upon cure of the anaerobically curable pressure sensitive adhesive.

Though conventional anaerobic threadlockers have been and remain well-received in the marketplace, there are shortcomings for certain commercial applications that have been observed with the use of conventional liquid anaerobic threadlockers, as well as known non-flowable, thixotropic anaerobic-based threadlockers. For instance, oftentimes such compositions do not fully cure through large gaps. Also, because of their nature of anaerobic cure, portions of the adhesive which remain exposed to air once applied to the parts will have difficulty curing (absent a secondary cure mechanism that is triggered). Thus, external bondlines which remain exposed to air on a nut/bolt assembly oftentimes will remain liquid unless additional additives and cure measures are taken to ensure cure. As a result, liquid compositions at the external bondlines tend to migrate. In the case of conventional non-flowable compositions, which depend on the thixotropic and/or rheological properties of the composition for their non-flowability, these compositions will flow if the temperature to which they are exposed is high enough. Additionally, the resistance to solvents of cured products (that have portions which remain uncured, as noted above) may be poor, indicative of questionable integrity when environmental interaction occurs. This may lead to contamination problems and hazardous conditions for the surroundings.

Notwithstanding the state of the art, it would be desirable to provide alternative threadlocking systems, including threaded members comprising dry-to-touch threadlocking compositions, methods for forming such threaded members, and method for assembling such threaded members.

### SUMMARY

In one aspect, the present invention provides an anaerobically curable composition comprising:
a liquid anaerobically curable component;
a solid anaerobically curable component;
a solid thermoplastic polyether polyurethane resin; and
a curing component for curing the anaerobically curable components.

Advantageously, the compositions of the invention are substantially solid and may be used to provide any suitable solid form. The compositions of the invention may be used in any suitable application. For example they may be provided on threaded articles in solid form, provided in a thread form or provided in a tape form. The compositions of the invention may be provided on a carrier or may be in a self-supporting form.

The solid thermoplastic polyether polyurethane resin may have a molecular weight Mw in the range of from about 180,000 g/mol to about 260,000 g/mol, suitably in the range of from about 200,000 g/mol to about 240,000 g/mol, such as about 215,000 g/mol to 230,000 g/mol for example 220,000 g/mol to 225,000 g/mol for example about 223,000 g/mol, wherein the molecular weight Mw is as determined in accordance with ASTM D5296-05 (Standard Test Method for Molecular Weight Averages and Molecular Weight Distribution of Polystyrene by High Performance Size-Exclusion Chromatography).

The solid thermoplastic polyether polyurethane resin may have a melting point in the range of from 160° C. to 200° C. such as from 165° C. to 190° C. for example from 170° C. to 180° C.

The liquid anaerobically curable component may be present in an amount of from about 20 wt % to about 50 wt % based on the total weight of the curable composition, suitably in an amount of from about 30 wt % to about 40 wt % based on the total weight of the curable composition, such as about 36 wt % based on the total weight of the curable composition. When the liquid anaerobically curable component is present in an amount below about 20 wt % based on the total weight of the composition, the composition when applied to/coated onto a substrate may be too rigid/non-flowable and may thus not move sufficiently for example may not move into the space between reciprocal threads being threaded together, may have poor threadlocking performance, or may have poor adhesive performance. When the liquid anaerobically curable component is present in an amount above about 50 wt % based on the total weight of the composition the on-part integrity may be adversely affected and the composition may be too flowable/soft and for example a coating formed by the composition rupture easily when contacted with other surfaces such as those of handling equipment or other substrates including other substrates which may have had a coating applied. When the liquid anaerobically curable component is present in an amount of from about 20 wt % to about 50 wt % based on the total weight of the curable composition this provides the composition with an acceptable balance between threadlocking and/or adhesive performance and a composition which forms a coating with sufficient integrity and which cures to give good bond strengths, the integrity being required for application of the composition to a part to be bonded and the bond strength being required for the bonding end-use.

The solid anaerobically curable component may be present in an amount of from about 8 wt % to about 30 wt % based on the total weight of the composition, suitably in an amount of from about 10 wt % to about 25 wt % based on the total weight of the curable composition, such as from 15 wt % to about 22 wt % based on the total weight of the curable composition. Compositions comprising less than about 8 wt % of the solid anaerobically curable component tend to lack cohesive strength and may not be suited to on-part application. For example a coating formed by such a composition may rupture easily when contacted with other surfaces such as those of handling equipment or other substrates including other substrates which may have had a coating applied. Compositions comprising greater than about 30 wt % of the solid anaerobically curable component tend to form coatings which are too brittle for application to any parts which are to be bonded. When the solid anaerobically curable component is present in an amount of from about 8 wt % to about 30 wt % based on the total weight of the composition this provides the composition (when applied as a coating) with an acceptable balance between threadlocking and/or adhesive performance (when cured) and a composition that can be applied as a coating with sufficient integrity and strength.

The solid thermoplastic polyether polyurethane resin may be present in an amount of from about 10 wt % to about 30 wt %, based on the total weight of the curable composition, suitably in an amount of from about 18 wt % to about 25 wt % based on the total weight of the curable composition, such as about 20 wt % based on the total weight of the curable composition. Compositions comprising less than about 10 wt % of the solid thermoplastic polyether polyurethane component tend to have insufficient elastomeric properties to allow the composition to be adequately applied to a part to be bonded. Compositions comprising greater than about 30 wt % of the solid thermoplastic polyether polyurethane component tend to exhibit poor threadlocking/ adhesive properties. When the solid thermoplastic polyether polyurethane resin is present in an amount of from about 10 wt % to about 30 wt %, based on the total weight of the curable composition this provides the composition with an acceptable balance between threadlocking and/or adhesive performance and a composition that can form a coating with sufficient elastomeric properties to allow application of the composition to a part to be bonded.

The curing component for curing the anaerobically curable components may be present in an amount of from about 0.1 to about 10 wt % based on the total weight of the curable composition such as from about 1 to about 5 wt %, based on the total weight of the curable composition.

Suitably, the liquid anaerobically curable component comprises a liquid (meth)acrylate monomer component.

The liquid (meth)acrylate monomer component may be one or more selected from those having the formula:

H₂C═CGCO₂R⁸, wherein G is hydrogen, halogen or alkyl groups having from 1 to 4 carbon atoms, and R⁸ is selected from alkyl, cycloalkyl, alkenyl, cycloalkenyl, alkaryl, alkaryl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, carbonate, amine, amide, sulfur, sulfonate, sulfone and the like.

Suitably, the solid anaerobically curable component comprises one or more solid (meth)acrylate monomer components. For example, the solid anaerobically curable can be the reaction product of phenyl isocyanate and hydroxyethyl methacrylate (“HEMA”):

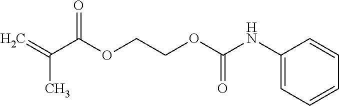 [SMILES: C=C(C)C(=O)OCCOC(=O)Nc1ccccc1]

which is 2-methacryloxylethyl urethane with a melting point of about 70-75° C.

The solid anaerobically curable component can also be the reaction product of 2 molar equivalents of HEMA with 1 molar equivalent diisocyanates such as isophorone diisocyanate (“IPDI”), 4,4′-methylenebis(cyclohexyl isocyanate) (“hMDI”), 1,5-cyclohexyl diisocyanate (“CHDI”). For example:

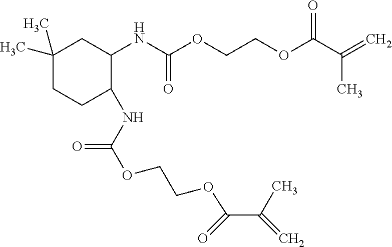 [SMILES: C=C(C)C(=O)OCCOC(=O)NC1CCC(C)(C)CC1NC(=O)OCCOC(=O)C(=C)C]

which is HEMA-IPDI-HEMA with a melting point of about 72-74° C.

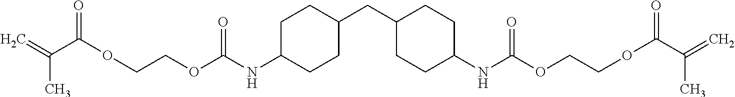 [SMILES: C=C(C)C(=O)OCCOC(=O)NC1CCC(CC2CCC(NC(=O)OCCOC(=O)C(=C)C)CC2)CC1]

which is HEMA-hMDI-HEMA with a melting point of about 75-85° C.

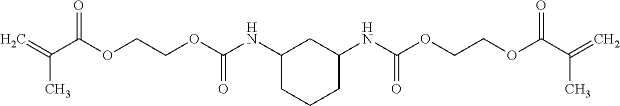 [SMILES: C=C(C)C(=O)OCCOC(=O)NC1CCCC(NC(=O)OCCOC(=O)C(=C)C)C1]

which is HEMA-CHDI-HEMA with a melting point of about 75-85° C.

The solid anaerobically curable component can also be a polyurethane methacrylate resin with a molecular weight >2000 g·mol and with a semi-crystalline polyester polyol backbone. An example of such a resin is given in International patent publication WO 2017168196A1 and is the reaction product of the polyol known as Dynacoll 7380 with toluene diisocyanate, followed by end capping with HEMA. These resins have a melting point in the range of 50-80° C.

Also of use as the solid anaerobically curable component are novolac vinyl ester resins which are the reaction products of novolac epoxy resins and methacrylate acids. Examples of these resins and their preparation are shown in U.S. Pat. No. 9,957,344. For example

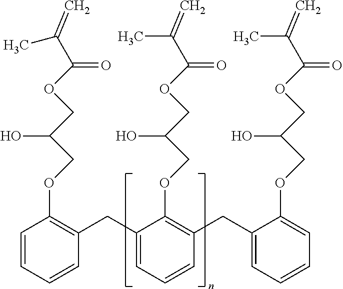

where n is an integer between 2-10 and the compound has a melting point of about 70-75° C.

Suitably, the curing component comprises one or more selected from APH, DE-p-T, DM-o-T, N,N-dimethyl para toluidine, N,N-diethanol para toluidine, N,N-dimethyl meta toluidine, indoline, 2-methylindoline, isoindoline, indole, 1,2,3,4-tetrahydroquinoline, 3-methyl-1,2,3,4-tetrahydro-quinoline, 2-methyl-1,2,3,4-tetrahydroquinoline, and 1,2,3,4-tetrahydroquinoline-4-carboxylic acid, and 1,2,3,4-tetrahydro-benzo(H)quinolin-3-ol.

An anaerobic curable composition of the invention may comprise a cure accelerator embraced by

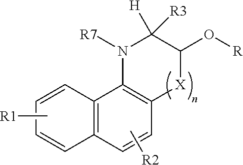

wherein X is CH₂, O, S, NR⁴, CR⁵R⁶ or C═O; R is one or more of hydrogen, alkyl, alkenyl, alkynl, hydroxyalkyl, hydroxyalkenyl, or hydroxyalkynl; R¹-R⁶ are each individually selected from hydrogen, halogen, amino, carboxyl, nitro, alkyl, alkenyl, alkynyl, hydroxyalkyl, hydroxyalkenyl, hydroxyalkynyl, or alkaryl; R⁷ is hydrogen or CHR⁸R⁹, wherein R⁸ and R⁹ are each individually selected from hydrogen, halogen, amino, carboxyl, nitro, alkyl, alkenyl, alkynyl, hydroxyalkyl, hydroxyalkenyl, hydroxyalkynyl, or alkaryl; and n is 0 or 1.

Optionally the cure accelerator above is used in combination with at least one co-accelerator, such a co-accelerator selected from the group consisting of amines, amine oxides, sulfonamides, metal sources, acids, and mixtures thereof.

For example the co-accelerator may be selected from the group consisting of triazines, ethanolamine, diethanolamine, triethanolamine, N,N dimethyl aniline, benzene sulphanimide, cyclohexyl amine, triethyl amine, butyl amine, saccharin, N,N-diethyl-p-toluidine, N,N-dimethyl-o-toluidine, acetyl phenylhydrazine, maleic acid, and mixtures thereof.

The cure accelerator may be

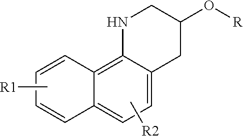

wherein R is one or more of hydrogen, alkyl, alkenyl, alkynl, hydroxyalkyl, hydroxyalkenyl, or hydroxyalkynl; and R¹ and R² are each individually selected from halogen, amino, carboxyl, nitro, alkyl, alkenyl, alkynyl, hydroxyalkyl, hydroxyalkenyl, hydroxyalkynyl, or alkaryl.

For example the cure accelerator may be selected from one or more of

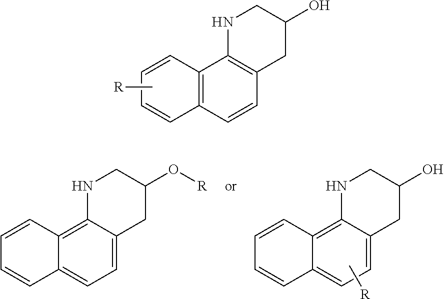

where R here is as defined above.

The cure accelerator may be

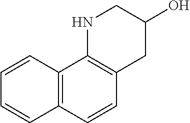 [SMILES: OC1CNc2c(ccc3ccccc23)C1]

1,2,3,4-tetrahydrobenzo-h-quinolin-3-ol.

The composition of the invention may further comprise an initiator of free radical polymerization such as a peroxide.

The initiator of free radical polymerization is one or more selected from cumene hydroperoxide (“CHP”), para-menthane hydroperoxide, t-butyl hydroperoxide (“TBH”), t-butyl perbenzoate, benzoyl peroxide, dibenzoyl peroxide, 1,3-bis(t-butylperoxyisopropyl)benzene, diacetyl peroxide, butyl 4,4-bis(t-butylperoxy)valerate, p-chlorobenzoyl peroxide, t-butyl cumyl peroxide, t-butyl perbenzoate, di-t-butyl peroxide, dicumyl peroxide, 2,5-dimethyl-2,5-di-t-butylperoxyhexane, 2,5-dimethyl-2,5-di-t-butyl-peroxyhex-3-yne, 4-methyl-2,2-di-t-butylperoxypentane, t-amyl hydroperoxide, 1,2,3,4-tetramethylbutyl hydroperoxide and combinations thereof. The initiator of free radical polymerisation may comprise an encapsulated peroxide.

The compositions of the invention may further comprise a cure accelerator in addition to or instead of those described above. For example, the cure accelerator may comprise one or more metallocenes such as ferrocene, suitably, n-butyl ferrocene. Advantageously, the presence of a cure accelerator facilitates cure of the compositions of the invention on “non-active” or “passive” substrates, such as plastic substrates.

The composition of the invention may further comprise at least one solvent. The use of a solvent may be beneficial, for example, for formulation or dispensing purposes. Suitably, the at least one solvent may be selected from the group comprising: tetrahydrofuran, dichloromethane, chloroform, or a combination thereof.

However, wherever weight percentages are used, they are based on the total weight of the composition without solvent.

Suitably, the compositions of the invention may be provided in any suitable solid form including tape form, filament form or as a coating applied to a substrate including for example a filament or thread made from another material such as a nylon or polyester thread. A tape or filament of the solid composition may be less than 100 microns (μm) thick. A tape or filament may be applied by winding i.e. in a similar manner to current PTFE tape or thread-sealing cord used to seal joints in pipework. It will be appreciated that the solid form can be to a desired pattern or layout including a stick, a tape, a filament, a gasket or a patch. The composition in its solid form such as tape form, or filament form may have sufficient integrity to be handled without breaking. The composition in its solid form such as tape form or filament form can be applied to substrates, for example metal bolts, at room temperature. The composition in its solid form such as tape form or filament form may be capable of thermal resistance at temperatures of at least 150° C., for example 180° C. This means that the composition is robust enough to maintain performance at the temperatures of common industrial environments. Even at elevated temperatures, the composition in its solid form such as tape form, or filament form may be non-tacky and dry to touch such that a carrier, such as a release liner, is not required. The composition in tape form, or filament may be rolled up onto itself and will not adhere to itself as it is non-tacky and dry to touch. Alternatively the tape form, or filament form may comprise an anaerobically curable composition as described herein and one or more release liners. For example, when the temperature at which the composition is to be stored is above 40° C. a release liner may be useful as at temperatures above 40° C. the non-tacky composition may become tacky and may adhere to itself. As mentioned above the composition of the invention may also be any suitable solid form including tape form, filament form or as a (solid, dry to touch) coating applied to a substrate including for example a filament or thread made from another material such as a nylon or polyester thread.

Another aspect of the present invention provides a cured composition formed by curing the inventive curable compositions claimed herein. Suitably, the curable composition may be cured by exposure to an anaerobic environment. The curable composition may for example be cured by exposure to an anaerobic environment for a period in the range of from about 1 minute to 30 minutes, such as from about 1 minute to about 20 minutes. Optionally, the curable composition may be cured within the temperature range of from about 40° C. to about 100° C. For example, the curable composition may be cured by exposure to an anaerobic environment for a period in the range of from about 1 minute to about 30 minutes, within a temperature range of from about 40° C. to about 100° C.

Once cured, the compositions of the present invention desirably exhibit breakaway torque values of greater than 10 Nm for black oxide mild steel or zinc phosphate substrates, when assessed on M10 nuts and bolts according to ISO 10964. Furthermore, the cured compositions of the present invention desirably show breakloose torque values greater than 10 Nm at temperatures up to 180° C., for example at 50° C., 80° C., 120° C., 150° C., or 180° C., when assessed on zinc phosphate M10 nuts and bolts according to ISO 10964.

In another aspect the present invention provides a threaded member comprising at least one threaded face, wherein said at least one threaded face comprises an anaerobically curable composition as described herein. For example, said anaerobically curable composition may be in tape form or filament form. Alternatively it may be in the form of a composition applied to/coated unto thread made from a different material. The tape, thread or fibre may be applied to the treaded face for example by wrapping said tape, thread or fibre at least partially around the threaded face. For example, said anaerobically curable composition may be coated onto threads or fibres made from different materials to form coated threads or fibres. The coated thread or fibres may be applied to the treaded face for example by wrapping said coated thread of fibre at least partially around the threaded face.

In yet a further aspect, the present invention provides a method of manufacturing a threaded member comprising a threadlocking composition, comprising: providing at least one threaded member comprising at least one threaded face, applying to said at least one threaded face, an anaerobically curable composition as described herein. Suitably, the anaerobically curable composition is applied to the at least one threaded face in tape form, filament form or as a coating applied to a substrate such as thread form or fibre formed from a different material, for example the tape, filament or coated substrate may be wrapped at least partially around the at least one threaded face of the treaded member. Suitably the anaerobically curable composition in tape form, filament or coated substrate may be non-tacky and dry to touch such that a carrier, such as a release liner, is not required.

In still a further aspect, the present invention provides a method of assembling threaded members comprising: providing a first threaded member, comprising at least one threaded face; applying an anaerobically curable composition as described herein to said at least one threaded face; providing a second threaded member capable of matingly engaging said first threaded member; matingly engaging said first and second threaded members and thereby exposing said anaerobically curable composition to an anaerobic environment for a time sufficient for said anaerobically curable composition to cure between said first and second threaded members.

Also provided is a method for manufacturing a tape, thread, or fibre for threadlocking comprising the steps of:
mixing at least one solid thermoplastic polyether polyurethane resin; optionally having a molecular weight Mw in the range of from about 180,000 g/mol to about 260,000 g/mol, suitably in the range of from about 200,000 g/mol to about 240,000 g/mol, such as about 215,000 g/mol to 230,000 g/mol for example 220,000 g/mol to 225,000 g/mol for example about 223,000 g/mol, wherein the molecular weight Mw is as determined in accordance with ASTM D5296-05, and optionally having a melting point from 160° C. to 200° C., such as from 165° C. to 190° C. for example from 170° C. to 180° C., and solvent, suitably wherein the solvent may be selected from tetrahydrofuran, dichloromethane, chloroform, or a combination thereof;
mixing therewith: a liquid anaerobically curable component, a solid anaerobically curable component and a curing component for curing the anaerobically curable components; optionally, adding additives to the mixture;
forming the mixture into a desired form for example by casting, or extruding and/or applying the mixture to a carrier such as a threaded article or a release liner;
removing the solvent and/or allowing the solvent to evaporate, to thereby form a tape, thread, or fibre comprising the anaerobically curable composition as described herein and optionally a carrier.

### DETAILED DESCRIPTION

As outlined above, the present invention provides an anaerobically curable composition comprising: a liquid anaerobically curable component; a solid anaerobically curable component; a solid thermoplastic polyether polyurethane resin; and a curing component for curing the anaerobically curable components.

### Definitions and Standard Test Methods

The term “liquid” means in a liquid state within the temperature range of from about 5° C. to 30° C., suitably in a liquid state at room temperature and at atmospheric pressure.

The term “solid” means in a solid state within the temperature range of from about 5° C. to 40° C., suitably in a solid state at room temperature and at atmospheric pressure. Solid state is defined as the state of matter in which materials are not fluid but retain their boundaries without support, the atoms or molecules occupying fixed positions with respect to each other and unable to move freely.

In respect of the present invention tack free means dry to the touch yet the composition will not flake off during handling or use. For example an article to which the composition of the invention is applied is dry to the touch. An article to which a composition of the invention has been applied is considered dry to the touch if 20 of such articles are individually placed on dry tissue paper for four hours and there is no change in appearance of the tissue.

Molecular weights disclosed herein are determined in accordance with ISO 13886-19008, “Binders for paints and varnishes—Gel permeation chromatography (GPC)—Part 1: Tetrahydrofuran (THF) as eluent”.

Melting and re-solidification temperature ranges were measured in accordance with ISO 1137-1:2016 “Plastics—Differential scanning calorimetry (DSC)—Part 1 General Principles”.

### Liquid Anaerobically Curable Component

Suitably, the liquid anaerobically curable component comprises a liquid (meth)acrylate monomer component.

The liquid (meth)acrylate component may comprises one or more (meth)acrylate monomers selected from beta-carboxy ethyl acrylate, isobornyl acrylate, n-octyl acrylate, n-decyl acrylate, cyclohexyl acrylate, tetrahydrofurfuryl acrylate, 2-ethylhexyl acrylate, ethoxyethoxyethyl acrylate, ethoxylated phenyl monoacrylate, hydroxyethyl acrylate, hydroxypropyl acrylate, hydroxybutyl acrylate, isooctyl acrylate, n-butyl acrylate, neopentyl glycol diacrylate, ethylene glycol diacrylate, diethylene glycol diacrylate, dipropylene glycol diacrylate, triethylene glycol diacrylate, tetraethylene glycol diacrylate, 1,6-hexane diol diacrylate, tripropylene glycol diacrylate, glycerol triacrylate, trimethylol propane diacrylate, trimethylol propane triacrylate, pentaerythritol tetraacrylate, phenoxyethyl acrylate, hydroxyethyl methacrylate, hydroxypropyl methacrylate, cyclohexyl methacrylate, glycerol mono- methacrylate, glycerol 1,3-dimethacrylate, trimethyl cyclohexyl methacrylate, methyl triglycol methacrylate, isobornyl methacrylate, trimethylolpropane trimethacrylate, neopentyl glycol dimethacrylate, ethylene glycol dimethacrylate, diethylene glycol dimethacrylate, 1,6-hexanediol dimethacrylate, hydroxybutyl methacrylate, tetrahydrofurfuryl methacrylate, cyclohexyl methacrylate, phenoxyethyl methacrylate, glycerol methacrylate, glycidyl methacrylate, methyl methacrylate and methacrylic acid and mixtures thereof.

Preferred liquid (meth)acrylate monomers include 2-hydroxyethyl methacrylate, 2-hydroxypropyl methacrylate, tetrahydrofurfuryl methacrylate, isobornyl methacrylate, phenoxyethyl methacrylate and methacrylic acid.

One or more suitable (meth)acrylates may be chosen from among polyfunctional (meth)acrylates, such as, but not limited to, di-or tri-functional (meth)acrylates like polyethylene glycol di(meth)acrylates, diethylene glycol dimethacrylate, triethylene glycol dimethacrylate (“TRIEGMA”), tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate, polyethyleneglycol di(meth)acrylates and bisphenol-A mono and di(meth)acrylates, such as ethoxylated bisphenol-A (meth)acrylate (“EBIPMA”), and bisphenol-F mono and di(meth)acrylates, such as ethoxylated bisphenol-F (meth)acrylate.

For example, the redox curable component may include Bisphenol A dimethacrylate:

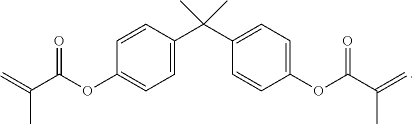 [SMILES: C=C(C)C(=O)Oc1ccc(C(C)(C)c2ccc(OC(=O)C(=C)C)cc2)cc1]

Suitably, the redox curable composition may include ethoxylated bisphenol A di(meth)acrylate.

Still other (meth)acrylates that may be suitable for use herein are silicone (meth)acrylate moieties (“SiMA”), such as those taught by and claimed in U.S. Pat. No. 5,605,999 (Chu), the disclosure of which is hereby expressly incorporated herein by reference.

Other suitable materials may be chosen from polyacrylate esters represented by the formula:

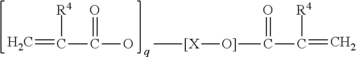

where R⁴ here is a radical selected from hydrogen, halogen or alkyl of from 1 to about 4 carbon atoms; q is an integer equal to at least 1, and preferably equal to from 1 to about 4; and X is an organic radical containing at least two carbon atoms and having a total bonding capacity of q plus 1. With regard to the upper limit for the number of carbon atoms in X, workable monomers exist at essentially any value. As a practical matter, however, a general upper limit is about 50 carbon atoms, such as desirably about 30, and desirably about 20.

For example, X can be an organic radical of the formula:

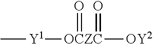

where each of Y¹ and Y² is an organic radical, such as a hydrocarbon group, containing at least 2 carbon atoms, and desirably from 2 to about 10 carbon atoms, and Z is an organic radical, preferably a hydrocarbon group, containing at least 1 carbon atom, and preferably from 2 to about 10 carbon atoms. Other materials may be chosen from the reaction products of di- or tri-alkylolamines (e.g., ethanolamines or propanolamines) with acrylic acids, such as are disclosed in French Pat. No. 1,581,361.

Suitable oligomers with (meth)acrylate functionality may also be used. Examples of such (meth)acrylate-functionalized oligomers include those having the following general formula:

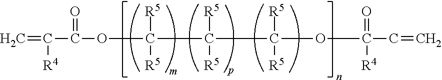

where R⁵ here represents a radical selected from hydrogen, alkyl of from 1 to about 4 carbon atoms, hydroxy alkyl of from 1 to about 4 carbon atoms, or

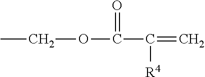

where R⁴ here is a radical selected from hydrogen, halogen, or alkyl of from 1 to about 4 carbon atoms; R⁶ here is a radical selected from hydrogen, hydroxyl, or

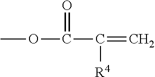

m is an integer equal to at least 1, e.g., from 1 to about 15 or higher, and desirably from 1 to about 8; n is an integer equal to at least 1, e.g., 1 to about 40 or more, and desirably between about 2 and about 10; and p is 0 or 1.

Typical examples of acrylic ester oligomers corresponding to the above general formula include di-, tri- and tetraethyleneglycol dimethacrylate; di(pentamethyleneglycol)dimethacrylate; tetraethyleneglycol diacrylate; tetraethyleneglycol di(chloroacrylate); diglycerol diacrylate; diglycerol tetramethacrylate; butyleneglycol dimethacrylate; neopentylglycol diacrylate; and trimethylolpropane triacrylate.

While di- and other polyacrylate esters, and particularly the polyacrylate esters described in the preceding paragraphs, can be desirable, monofunctional acrylate esters (esters containing one acrylate group) also may be used.

Suitable compounds can be chosen from among are cyclohexylmethacrylate, tetrahydrofurfuryl methacrylate, hydroxyethyl acrylate, hydroxypropyl methacrylate, t-butylaminoethyl methacrylate, cyanoethylacrylate, and chloroethyl methacrylate.

Another useful class of materials are the reaction product of (meth)acrylate-functionalized, hydroxyl- or amino-containing materials and polyisocyanate in suitable proportions so as to convert all of the isocyanate groups to urethane or ureido groups, respectively.

The so-formed (meth)acrylate urethane or urea esters may contain hydroxy or amino functional groups on the non-acrylate portion thereof. (Meth)acrylate esters suitable for use may be chosen from among those of the formula:

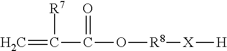

where X is selected from —O— and

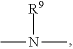

where R⁹ is selected from hydrogen or lower alkyl of 1 through 7 carbon atoms; R 7 here is selected from hydrogen, halogen (such as chlorine) or alkyl (such as methyl and ethyl radicals); and R⁸ is a divalent organic radical selected from alkylene of 1 through 8 carbon atoms, phenylene and naphthylene.

These groups upon proper reaction with a polyisocyanate, yield a monomer of the following general formula:

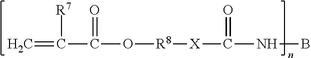

where n is an integer from 2 to about 6; B is a polyvalent organic radical selected from alkyl, alkenyl, cycloalkyl, cycloalkenyl, aryl, alkaryl, alkaryl and heterocyclic radicals both substituted and unsubstituted, and combinations thereof; and R⁷, R⁸ and X have the meanings given above.

Depending on the nature of B, these (meth)acrylate esters with urea or urethane linkages may have molecular weights placing them in the oligomer class (such as about 1,000 g/mol up to about 5,000 g/mol) or in the polymer class (such as about greater than 5,000 g/mol).

Other unsaturated reactive monomers and oligomers such as styrenes, maleimides, vinyl ethers, allyls, allyl ethers and those mentioned in U.S. Pat. No. 6,844,080B1 (Kneafsey et al.) can be used. Vinyl resins as mentioned in U.S. Pat. No. 6,433,091 (Xia) can also be used. Methacrylate or acrylate monomers containing these unsaturated reactive groups can also be used.

Of course, combinations of these (meth)acrylates and other monomers may also be used.

### Solid Anaerobically Curable Component

The anaerobically curable composition of the invention comprises a solid anaerobically curable component. The solid anaerobically curable component may be a solid (meth)acrylate resin. Suitably the solid (meth)acrylate resin is selected from the list of suitable (meth)acrylate components listed above.

### Solid Thermoplastic Polyether Polyurethane Resin

The anaerobically curable composition of the invention comprises a solid thermoplastic polyether polyurethane resin. The solid thermoplastic polyether polyurethane resin may have molecular weight Mw in the range of from about 180,000 g/mol to about 260,000 g/mol, suitably in the range of from about 200,000 g/mol to about 240,000 g/mol, such as about 215,000 g/mol to 230,000 g/mol for example 220,000 g/mol to 225,000 g/mol for example about 223,000 g/mol, wherein the molecular weight Mw is as determined in accordance with ASTM D5296-05. The solid thermoplastic polyether polyurethane resin may have a melting point from 160° C. to 200° C., such as from 165° C. to 190° C. for example from 170° C. to 180° C. Suitable solid thermoplastic polyether polyurethane resins include Pearlbond® 960, available from Lubrizol, Carrer del Gran Vial, 17, 08160 Montmelo, Barcelona, Spain. Pearlbond® 960 is a solid thermoplastic polyether polyurethane resin having a Mw of 222,906 as determined in accordance with D5296-05 (Standard Test Method for Molecular Weight Averages and Molecular Weight Distribution of Polystyrene by High Performance Size-Exclusion Chromatography) and having a melting point over the range of 170° C. to 180° C.

### EXAMPLES

Anaerobically curable compositions as provided in Table 1 were formulated in tape form.

TABLE 1
Composition

| | 1 | 2 | 3 | 4 | 5 | 6 |
|---|---|---|---|---|---|---|
| | Amt | Amt | Amt | Amt | Amt | Amt |
| Component | (wt %) | (wt %) | (wt %) | (wt %) | (wt %) | (wt %) |
| Pearlbond 960 polyether- | 10 | 10 | 10 | 10 | 10 | 10 |
| based thermoplastic | | | | | | |
| polyurethane | | | | | | |
| 1,4-butanediol dimethacrylate | | | | | | 3 |
| Methacrylate resin* | 10 | 10 | 10 | 10 | 10 | 10 |
| Triallyl Cyanurate | 5 | 5 | 5 | 5 | 5 | 5 |
| P84 NT - Polyimide Powder | 5 | 5 | 5 | 5 | 5 | 5 |
| Methacrylated Novolac resin | | | | | | 5 |
| Propoxylated Bisphenol-A- | 10 | 10 | 10 | 10.25 | 10 | 5 |
| Fumarate Polyester | | | | | | |
| Polyethylene glycol | | 6.65 | 6.65 | 6.65 | 6.65 | 3 |
| dimethacrylate | | | | | | |
| Triethylene glycol | 6.65 | | | | | |
| dimethacrylate | | | | | | |
| Polyethylene Powder | 1 | 1 | 1 | 1.25 | 1 | 2 |
| Acetylphenylhydrazine | 0.2 | 0.2 | 0.25 | 0.2 | | 0.25 |
| Saccharin | 0.25 | 0.25 | 0.315 | 0.25 | 0.25 | 0.3 |
| 1,2,3,4-tetrahydro- | | | | | 0.2 | |
| benzo(H)quinolin-3-ol | | | | | | |
| Cumene hydroperoxide | 1.25 | 1.25 | 1.56 | 1.25 | 1.25 | 1.3 |
| Tetra sodium EDTA (3.5 wt % | 0.5 | 0.5 | 0.05 | 0.5 | 0.5 | 0.5 |
| in water/propylene glycol) | | | | | | |
| Red dye** | 0.05 | 0.05 | 0.05 | 0.05 | 0.05 | 0.05 |
| PL2152 Methacrylate-based | | | | | | 0.5 |
| adhesion promoter | | | | | | |
| Naphthoquinone (5 wt % in | 0.1 | 0.1 | 0.125 | 0.1 | 0.1 | 0.1 |
| polyethylene glycol | | | | | | |
| dimethacrylate) | | | | | | |
| Ethyl Acetate | 50 | 50 | 50 | 50 | 50 | 50 |

*The resin used was a polyurethane methacrylate resin, the reaction product of a di-isocyanate end capped with a methacrylate (HPMA).
**The red dye is a non-ionic polymeric colorant. In these examples, Reactint ® Red, which is available commercially from Milliken (no CAS number assigned), was used.
“Amt” = amount.

The compositions of Table 1 were prepared as follows: The solid thermoplastic polyether polyurethane was dissolved in ethyl acetate at a temperature of about 70° C. before transferring to a Speedmixer DAC150.147. The remaining components were then added and mixing was continued until each of the components had dissolved. For compositions comprising microencapsulated peroxides or methacrylates, the encapsulated components will not dissolve and mixing was continued until the microencapsulated components had formed a dispersion in the solution. Each solution was then cast onto siliconized polyester release liner (HiFi SR4-122, 75 micron thick) using an Elcometer 4340 automatic film coater maintained with a coating plate temperature of 30° C. After coating the ethyl acetate was allowed to evaporate the heated coating plate. Dry to touch films were obtained.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The threadlocking performance of each of the films formed from the compositions of the invention specified in Table 1 were assessed on M10 nuts and bolts according to ISO 10964. The compositions of the invention were applied to M10 bolts, and threaded assemblies were formed with M10 nuts capable of matingly engaging said M10 bolts. The threaded assemblies were kept at room temperature (20° C. to 25° C.) for 24 hours, prior to measuring break and prevail strengths of the cured compositions. The results for each composition on a variety of substrates are provided in Table 2.

TABLE 2
Breakaway Torque (Nm)

| | Composition | | | | | |
|---|---|---|---|---|---|---|
| Substrate | 1 | 2 | 3 | 4 | 5 | 6 |
| Stainless Steel | 10.9 | 9.7 | 9.4 | 12.1 | 11.2 | 20.4 |
| Black Oxide Mild Steel | 20 | 19.2 | 19.2 | 19 | 13 | 23.6 |
| Zinc Phosphate | 15.1 | 11.2 | 11.7 | 16.4 | 12 | 22.3 |
| Zinc Dichromate | 9.8 | 8.4 | 6.8 | 9.2 | 8.4 | 14.3 |
| Brass | 7.2 | 7.2 | 8.6 | 8.8 | 5.6 | 9.2 |

The compositions of the invention were applied to M10 zinc phosphate bolts with metal spacer, and threaded assemblies were formed with M10 nuts capable of matingly engaging said M10 bolts with an application force of 5 Nm. The threaded assemblies were kept at room temperature (20° C. to 25° C.) for 168 hours, prior to measuring break and prevail strengths of the cured compositions at the specified temperatures. The results for each composition at a variety of temperatures are provided in Table 3.

TABLE 3
Breakloose Torque (Nm)

| Temperature | 1 | 2 | 3 | 4 | 5 | 6 |
|---|---|---|---|---|---|---|
| 22° C. | 23.0 | 22.3 | 24.3 | 23.0 | 20.7 | 26.5 |
| 50° C. | 14.7 | 15.3 | 14.7 | 12.8 | 10.7 | 18.5 |
| 80° C. | 12.7 | 14.3 | 15.0 | 13.5 | 10.5 | 13.8 |
| 120° C. | 15.5 | 13.3 | 12.8 | 12.7 | 12.3 | 14.3 |
| 150° C. | 15.0 | 12.3 | 13.7 | 10.5 | 15.7 | 11.5 |
| 180° C. | 12.8 | 11.0 | 10.7 | 11.8 | 11.2 | 10.8 |

1. An anaerobically curable composition comprising:
a liquid anaerobically curable component;
a solid anaerobically curable component;
a solid thermoplastic polyether polyurethane resin; and
a curing component for curing the anaerobically curable components;
wherein the solid thermoplastic polyether polyurethane resin has a molecular weight Mw in the range of from about 180,000 g/mol to about 260,000 g/mol, wherein the molecular weight Mw is as determined in accordance with ASTM D5296-05.

2. The composition of claim 1, wherein the solid thermoplastic polyether polyurethane resin has a molecular weight Mw in the range from about 200,000 g/mol to about 240,000 g/mol, such as about 215,000 g/mol to 230,000 g/mol for example 220,000 g/mol to 225,000 g/mol for example about 223,000 g/mol, wherein the molecular weight Mw is as determined in accordance with ASTM D5296-05.

3. The composition of claim 1, wherein the solid thermoplastic polyether polyurethane resin has a melting point from 160° C. to 200° C.

4. The composition of claim 1, wherein the liquid anaerobically curable component is present in an amount of from about 20 wt % to about 50 wt % based on the total weight of the composition, based on the total weight of the curable composition.

5. The composition of claim 1, wherein the solid anaerobically curable component is present in an amount of from about 8 wt % to about 30 wt % based on the total weight of the composition based on the total weight of the curable composition.

6. The composition of claim 1, wherein the solid thermoplastic polyether polyurethane resin is present in an amount of from about 10 wt % to about 30 wt %, based on the total weight of the curable composition.

7. The composition of claim 1, wherein the curing component for curing the anaerobically curable components is present in an amount of from about 0.1 to about 10 wt % based on the total weight of the curable composition.

8. The composition of claim 1, wherein the liquid anaerobically curable component comprises a liquid (meth)acrylate monomer component.

9. The composition of claim 8, wherein the liquid (meth)acrylate monomer component is one or more selected from those having the formula: H₂C═CGCO₂R⁸, wherein G is hydrogen, halogen or alkyl groups having from 1 to 4 carbon atoms, and R⁸ is selected from alkyl, cycloalkyl, alkenyl, cycloalkenyl, alkaryl, alkaryl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, carbonate, amine, amide, sulfur, sulfonate, sulfone and the like.

10. The composition of claim 1 wherein the solid anaerobically curable component comprises one or more solid (meth)acrylate monomer components.

11. The composition of claim 1 wherein the curing component comprises one or more selected from the group consisting of 1-acetyl-2-phenylhydrazine, N,N-dimethyl para toluidine, N,N-diethyl para toluidine, N,N-diethanol para toluidine, N,N-dimethyl ortho toluidine, N,N-dimethyl meta toluidine, indoline, 2-methylindoline, isoindoline, indole, 1,2,3,4-tetrahydroquinoline, 3-methyl-1,2,3,4-tetrahydro-quinoline, 2-methyl-1,2,3,4-tetrahydroquinoline, 1,2,3,4-tetrahydroquinoline-4-carboxylic acid, and 1,2,3,4-tetrahydro-benzo(H)quinolin-3-ol.

12. The composition according to claim 1, further comprising an initiator of free radical polymerization.

13. The composition according to claim 12, wherein the initiator of free radical polymerization is one or more selected from the group consisting of: cumene hydroperoxide (“CHP”), para-menthane hydroperoxide, t-butyl hydroperoxide (“TBH”), t-butyl perbenzoate, benzoyl peroxide, dibenzoyl peroxide, 1,3-bis(t-butylperoxyisopropyl)benzene, diacetyl peroxide, butyl 4,4-bis(t-butylperoxy)valerate, p-chlorobenzoyl peroxide, t-butyl cumyl peroxide, t-butyl perbenzoate, di-t-butyl peroxide, dicumyl peroxide, 2,5-dimethyl-2,5-di-t-butylperoxyhexane, 2,5-dimethyl-2,5-di-t-butyl-peroxyhex-3-yne, 4-methyl-2,2-di-t-butylperoxypentane, t-amyl hydroperoxide, 1,2,3,4-tetramethylbutyl hydroperoxide and combinations thereof.

14. The composition according to claim 12, wherein the initiator of free radical polymerisation comprises an encapsulated peroxide.

15. The composition according to claim 1, further comprising a cure accelerator.

16. The composition according to claim 15, wherein the cure accelerator comprises one or more metallocenes and/or a cure accelerator embraced by 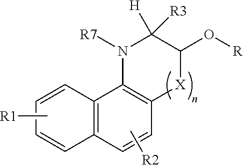
wherein X is CH₂, O, S, NR⁴, CR⁵R⁶ or C═O; R is one or more of hydrogen, alkyl, alkenyl, alkynl, hydroxyalkyl, hydroxyalkenyl, or hydroxyalkynl; R¹-R⁶ are each individually selected from hydrogen, halogen, amino, carboxyl, nitro, alkyl, alkenyl, alkynyl, hydroxyalkyl, hydroxyalkenyl, hydroxyalkynyl, or alkaryl; R⁷ is hydrogen or CHR⁸R⁹, wherein R⁸ and R⁹ are each individually selected from hydrogen, halogen, amino, carboxyl, nitro, alkyl, alkenyl, alkynyl, hydroxyalkyl, hydroxyalkenyl, hydroxyalkynyl, or alkaryl; and n is 0 or 1.

17. The composition according to claim 1 provided in tape form, filament form or in the form of a coated substrate.

18. The composition according to claim 1 provided as a coating on a thread or a fibre.

19. A tape comprising an anaerobically curable composition according to claim 1 and one or more release liners.

20. A threaded member comprising at least one threaded face, wherein said at least one threaded face comprises an anaerobically curable composition according to f claim 1, optionally wherein the anaerobically curable composition is in tape form, filament form or in the form of a coated substrate, and optionally wherein said anaerobically curable composition in tape form, filament form or in the form of a coated substrate is applied to the threaded face.

21. A method of manufacturing a threaded member comprising a threadlocking composition, comprising:
a. providing at least one threaded member comprising at least one threaded face,
b. applying to said at least one threaded face, an anaerobically curable composition according to claim 1.

22. The method of manufacturing a threaded member according to claim 21, wherein the anaerobically curable composition is in tape form, filament form or in the form of a coated substrate and optionally wherein the anaerobically curable composition in tape form, filament form or in the form of a coated substrate is wrapped at least partially around the at least one threaded face of the threaded member.

23. A method of assembling threaded members comprising:
providing a first threaded member, comprising at least one threaded face;
applying an anaerobically curable composition according to claim 1 to said at least one threaded face;
providing a second threaded member capable of matingly engaging said first threaded member;
matingly engaging said first and second threaded members and thereby exposing said anaerobically curable composition to an anaerobic environment for a time sufficient for said anaerobically curable composition to cure between said first and second threaded members.

24. The method according to claim 23, wherein the anaerobically curable composition is in tape form, filament form or in the form of a coated substrate and optionally wherein the anaerobically curable composition in tape form, filament form or in the form of a coated substrate is wrapped at least partially around said at least one threaded face.

25. A method for manufacturing a tape, thread, or fibre for threadlocking comprising the steps of:
mixing at least one solid thermoplastic polyether polyurethane resin; optionally having a molecular weight Mw in the range of from about 180,000 g/mol to about 260,000 g/mol, wherein the molecular weight Mw is as determined in accordance with ASTM D5296-05, and optionally having a melting point from 160° C. to 200° C., and solvent, suitably wherein the solvent is selected from tetrahydrofuran, dichloromethane, chloroform, or a combination thereof;
mixing therewith: a liquid anaerobically curable component, a solid anaerobically curable component and a curing component for curing the anaerobically curable components; optionally, adding additives to the mixture;
forming the mixture into a desired form for example by casting and/or applying the mixture to a carrier;
removing the solvent and/or allowing the solvent to evaporate, to thereby form a tape, thread, or fibre comprising the anaerobically curable composition as described herein and optionally a carrier.
